(19) United States
(12) Patent Application Publication
(10) Pub. No.: US 2006/0266383 A1
(43) Pub. Date: Nov. 30, 2006

(54) Systems and methods for removing wafer edge residue and debris using a wafer clean solution

(75) Inventors: Joe G. Tran, Flower Mound, TX (US); Brian K. Kirkpatrick, Allen, TX (US); Alfred J. Griffin JR., Dallas, TX (US)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/141,532

(22) Filed: May 31, 2005

(51) Int. Cl. B08B 3/04

(52) U.S. Cl. 134/34; 134/36; 134/33; 134/94.1; 134/95.3; 134/148; 134/153; 134/902

(57) ABSTRACT

A system (500) for removing wafer edge residue from a target wafer (508) is disclosed. A wafer holding mechanism (502) holds and optionally rotates the target wafer (508). A solution dispenser (504) applies a residue remover solution (506) to an edge/beveled surface at an outer edge of the wafer (508) by directing the residue remover solution (506) to a target location on the wafer (508) causing the residue remover solution (506) to come in contact with the edge surface of the wafer (508). The residue remover solution (506) contains an etch component that etches semiconductor material from the edge surface of the wafer (508). As a result, underlying semiconductor material below strongly adhered residue is removed thereby dislodging the strongly adhered residue.

### FIELD OF INVENTION

The present invention relates generally to semiconductor devices and more particularly to methods and systems for removing wafer edge residue.

### BACKGROUND OF THE INVENTION

Semiconductor devices are formed on semiconductor wafers by performing a number of fabrication processes. For example, layers are formed by depositing materials, layers are patterned by employing etch processes, trenches are formed in substrates and filled with material, surfaces of the devices are planarized and cleaned, and the like.

As a result of these fabrication processes, residues, including debris and contaminants, can be left on semiconductor wafers. For example, polishing/planarizing processes are typically employed to planarize layers deposited on the wafer. The polishing processes employ a chemical mechanical slurry and pad that mechanically and chemically planarize the wafer surfaces. After polishing, slurry residue is generally cleaned or scrubbed from wafer surfaces by mechanical scrubbing devices, such as polyvinyl acetate (PVA) brushes. These conventional cleaning processes tend to remove a substantial portion of the slurry residue, but some particles can remain as residue, particularly on edges of the wafer.

Another source of residue is due to metal film deposition. A clamp ring may be employed to secure a wafer to a heated pedestal within a deposition chamber to shield wafer edges from film disposition, such as to prevent metal from depositing along wafer edges and shorting subsequently formed devices as a result. Because the wafer and clamp ring possess different coefficients of thermal expansion, each expands at a different rate during metal film deposition. The shear force between the clamp ring and the wafer's edge may also generate edge particles that serve as a residue source.

Patterning operations are another potential source of residue. Patterning processes employ photoresist masks that can leave ashed resist as contamination or residue afterwards. Additionally, deposited materials, including metals and non-metals, can undesireably deposit on wafer edges as residue. Still other contaminants can be formed on the wafer edges from doping or ion implantation processes.

These residues can be sources of defects in later formed semiconductor structures. For example, layers can be formed on the residues or contaminants leading to blistering, delamination, undesired voids, and the like.

Some types of residue adhere to wafer edges more strongly than others and are, therefore, more troublesome to remove and prevent from contaminating subsequent processes. For example, wafer holding mechanisms, including pedestals, are often comprised at least partly of carbon material. The wafer holding mechanisms frequently grab wafers on their edges. As a result, the wafer holding mechanisms can leave carbon residue that is strongly adhered to the wafer edges. Such strongly adhered residue is not generally removable by conventional mechanisms.

### SUMMARY OF THE INVENTION

The following presents a simplified summary in order to provide a basic understanding of one or more aspects of the invention. This summary is not an extensive overview of the invention, and is neither intended to identify key or critical elements of the invention, nor to delineate the scope thereof. Rather, the primary purpose of the summary is to present some concepts of the invention in a simplified form as a prelude to the more detailed description that is presented later.

The present invention facilitates semiconductor device fabrication by removing strongly adhered residue, including debris and contaminants, from edge/beveled surfaces of wafers with a residue remover solution. The strongly adhered residue, such as residue containing carbon and fluorine, is not typically removed by conventional clean processes. This residue can subsequently interfere with formation of other layers and degrade fabricated device performance. However, the present invention applies the residue remover solution to the edge surfaces of wafers in order to remove present strongly adhered residue. As a result of its removal, the removed strongly adhered residue does not subsequently interfere with formation of other layers and/or degrade fabricated device performance.

In accordance with one aspect of the invention, a system for removing wafer edge residue from a target wafer is disclosed. A wafer holding mechanism holds and optionally rotates the target wafer. A solution dispenser applies a residue remover solution to an edge/beveled surface at an outer edge of the wafer by directing the residue remover solution to a target location on the wafer causing the residue remover solution to come in contact with the edge surface of the wafer. The residue remover solution contains an etch component that etches semiconductor material at the edge surface of the wafer. As a result, underlying semiconductor material below the strongly adhered residue is removed thereby dislodging the strongly adhered residue. Other systems and methods are disclosed.

To the accomplishment of the foregoing and related ends, the following description and annexed drawings set forth in detail certain illustrative aspects and implementations of the invention. These are indicative of but a few of the various ways in which the principles of the invention may be employed. Other aspects, advantages and novel features of the invention will become apparent from the following detailed description of the invention when considered in conjunction with the drawings.

### BRIEF DESCRIPTION OF THE DRAWINGS

FIG. 1 is a perspective view of an exemplary semiconductor wafer with edge residue.

FIG. 2 is a perspective view of another exemplary semiconductor wafer wherein edge residue has been removed.

FIG. 3 is a cross sectional view of an exemplary semiconductor device that is partially formed.

FIG. 4 is a cross sectional view of an exemplary semiconductor device that is partially formed and includes defect inducing residue.

FIG. 5 is a block diagram illustrating a system for removing wafer edge residue in accordance with an aspect of the present invention.

FIG. 6 is a view illustrating a solution dispenser within an edge residue removal system that directs a residue remover solution toward a bottom surface of a wafer in accordance with an aspect of the present invention.

FIG. 7 is a view illustrating a solution dispenser within an edge residue removal system that directs a residue remover solution towards a top surface of a target wafer in accordance with an aspect of the present invention.

FIG. 8 is a view illustrating a solution dispenser within an edge residue removal system that selectively directs residue remover solution towards an edge surface in accordance with an aspect of the present invention.

FIG. 9 is a cross sectional view illustrating a solution dispenser comprising a capillary chuck in accordance with an aspect of the present invention.

FIG. 10 is a flow diagram illustrating a method for removing residue from edge surfaces of a semiconductor wafer in accordance with an aspect of the present invention.

FIG. 11 is a flow diagram illustrating a method for removing residue from edge surfaces of a semiconductor wafer in accordance with an aspect of the present invention.

### DETAILED DESCRIPTION OF THE INVENTION

One or more implementations of the present invention will now be described with reference to the attached drawings, wherein like reference numerals are used to refer to like elements throughout, and wherein the illustrated structures are not necessarily drawn to scale.

The present invention facilitates semiconductor device fabrication by removing strongly adhered residue from edge/beveled surfaces of wafers with a residue remover solution. The strongly adhered residue, such as residue containing carbon and fluorine, is not typically removed by conventional clean processes and can subsequently interfere with formation of other layers and/or degrade fabricated device performance. The present invention applies the residue remover solution to the edge surfaces of wafers in order to remove strongly adhered residue. As a result, the removed strongly adhered residue does not subsequently interfere with formation of other layers and/or degrade fabricated device performance.

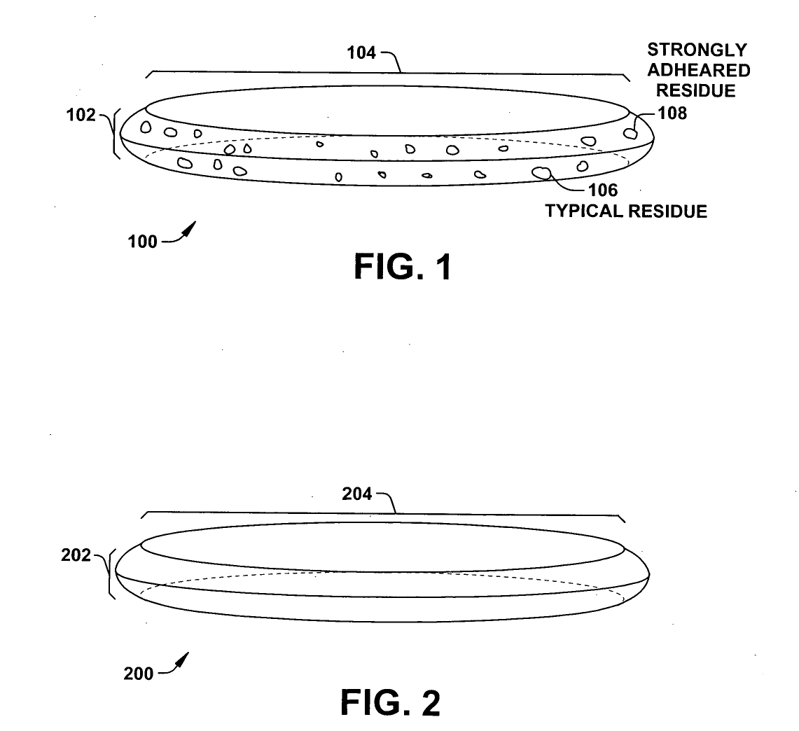

FIG. 1 is a perspective view of an exemplary semiconductor wafer 100 with edge residue. The wafer 100 is comprised of a semiconductor material, such as silicon. The wafer 100 has an edge surface 102, a top surface 104, and a bottom surface (not referenced with a reference numeral).

The top surface 104 is generally where semiconductor devices, such as transistors, capacitors, memory arrays, logic, and the like are formed. The top surface 104 can comprise a number of individual dies that have semiconductor devices formed therein. The wafer 100 has different layers and components formed therein according to the semiconductor devices being formed thereon and also according to a stage of fabrication. For example, at an initial stage of fabrication, the top surface 104 merely comprises silicon. At later stages of fabrication, isolation layers, gate structures, source drain regions, metallization layers, and the like can be formed thereon.

The edge surface 102 has a relatively curved or beveled surface and does not have devices formed thereon. The edge surface is often employed to hold or secure the wafer 100 during fabrication processes.

The fabrication processes employed to form semiconductor devices on the top surface 104 produce unwanted residue, including debris and contaminants that can remain on the top surface 104 and the edge surface 102 of the wafer 100. For example, chemical mechanical planarization is typically employed in device fabrication. This planarization employs a slurry that is typically cleaned from the top surface 104 by, for example, mechanical scrubbing devices. However, despite cleaning processes, some slurry can remain on the edge surface 102 and the top surface 104. Other sources of residue include metallization processes, which can leave metal materials as residue and debris. Additionally, patterning processes employ photoresist, which may not be completely removed and also becomes a source of residue. FIG. 1 shows typical residue 106 that can be present on the edge surface.

Some types of residue adhere to wafer edges more strongly than others and are, therefore, more troublesome to remove and prevent from contaminating subsequent processes. These types of residue are referred to as strongly adhered residue 108. For example, wafer holding mechanisms, including pedestals, are often comprised at least partly of carbon material. The wafer holding mechanisms frequently grab wafers on their edges. As a result, the wafer holding mechanisms can leave carbon residue that is strongly adhered to the wafer edges. Another example of strongly adhered residue is fluorine, which can be introduced by any fabrication process that employs fluorine. The strongly adhered residue 108 adheres to the wafer edge 102 more strongly than typical residue 106 at least partly because it contains carbon and/or fluorine. The strongly adhered residue 108, because of its strong adherence to the edge surface 102, is not generally removable by conventional mechanisms.

These residues 106 and 108 can be sources of defects in later formed semiconductor structures. The remaining residue, including debris and/or contaminants, can relocate from the edge surface 102 and onto the top surface 104. Subsequently performed fabrication processes and structures can be degraded due to the presence of the residues 106 and 108. For example, layers can be formed on the residues or contaminants leading to blistering, delamination, undesired voids, and the like. Further description of the defects that can be produced from the residues 106 and 108 are provided infra.

FIG. 2 is a perspective view of another exemplary semiconductor wafer 200 wherein edge residue has been removed. The wafer 200 is comprised of a semiconductor material, such as silicon. The wafer 200 has an edge surface 202, a top surface 204, and a bottom surface (not shown).

The top surface 204 is generally where semiconductor devices, such as transistors, capacitors, memory arrays, logic, and the like are formed. The top surface 204 can comprise a number of individual dies that have semiconductor devices formed therein. The wafer 200 has different layers and components formed therein according to the semiconductor devices being formed thereon and also according to a stage of fabrication. The edge surface 202 has a relatively curved surface and does not have devices formed thereon. The edge surface is often employed to hold or secure the wafer 200 during fabrication processes.

Residue, including conventional residue and strongly adhered residue were previously present, but were removed by systems and/or methods of the present invention.

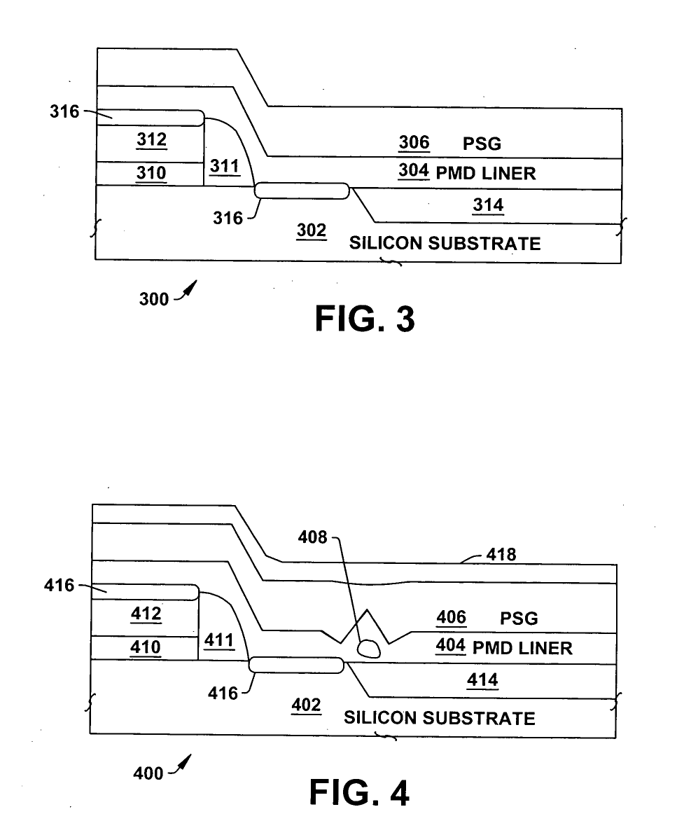

FIG. 3 is a cross sectional view of an exemplary semiconductor device 300 that is partially formed. It is appreciated that the view is exemplary in nature and is not intended to depict all of the layers and/or structures present within such as device.

The device 300 comprises a silicon substrate 302 wherein isolation regions 314 are formed therein. The isolation regions 314 are depicted as shallow trench isolation regions, in this example. A gate structure comprised of a gate dielectric layer 310 formed on the silicon substrate and a gate electrode layer 312 formed on the gate dielectric layer 310 is shown. Sidewall spacers 311 are formed on laterally edges of the gate structure and are comprised of an insulative material, such as silicon nitride. Silicide regions 316 are formed on the gate structure and elsewhere in order to mitigate contact resistance and facilitate operation of the device 300. The silicide regions are comprises of a suitable metal material, such as TiSi₂, CoSi₂, or NiSi. A PMD liner 304 is formed over the gate structures and the silicon substrate 302 as shown in FIG. 3. A phosphosilicate glass (PSG) layer 306, which is a poly metal dielectric (PMD) layer, is formed on the PMD liner 304. The phosphosilicate glass 306, like many dielectric/insulative materials, is typically formed by a high density plasma process that includes simultaneous etching and deposition components.

FIG. 4 is a cross sectional view of an exemplary semiconductor device 400 that is partially formed and includes a residue inducing defect. It is appreciated that the view is exemplary in nature and is not intended to depict all of the layers and/or structures present within such as device.

The device 400 comprises a silicon substrate 402 wherein isolation regions 414 are formed therein. The isolation regions 414 are depicted as shallow trench isolation regions, in this example. A gate structure comprised of a gate dielectric layer 410 formed on the silicon substrate and a gate electrode layer 412 formed on the gate dielectric layer 410 is shown. Sidewall spacers 411 are formed on laterally edges of the gate structure and are comprised of an insulative material, such as silicon nitride. Silicide regions 416 are formed on the gate structure and elsewhere in order to mitigate contact resistance and facilitate operation of the device 400. The silicide regions are comprises of a suitable metal material, such as TiSi₂, CoSi₂, or NiSi. A PMD liner 404 is formed over the gate structures and the silicon substrate 402 as shown in FIG. 4. A phosphosilicate glass (PSG) layer 406, which is a poly metal dielectric (PMD) layer, is formed on the PMD liner 404. The phosphosilicate glass 406, like many dielectric/insulative materials, is typically formed by a high density plasma process that includes simultaneous etching and deposition components.

Prior to and/or during formation of the PMD liner 404, strongly adhered residue 408, such as carbon and fluorine based residue, relocates from an edge surface to the position indicated in FIG. 4. Deposition processes, such as high density plasma based deposition processes, can cause the residue 408 to relocate to the undesired location. The residue causes the phosphosilicate glass layer 406 to be formed defectively. A conductive layer 418, such as platinum, can formed on the phosphosilicate glass 406 in order to facilitate detection of defects. Because of the residue particle 408, the PSG layer 406, in this example, is formed improperly and a subsequent planarization process can open a hole or void where the residue 408 is located. As a result of the residue particle 408, the semiconductor device 400 is defective as formed and, in some cases, not properly operate. The residue 408 can causes undesired shorting, undesired open circuits, and the like.

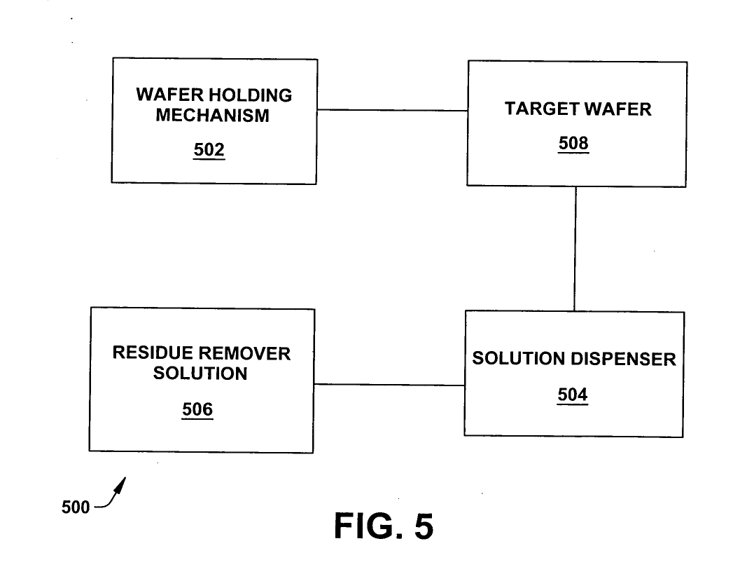

FIG. 5 is a block diagram illustrating a system 500 for removing wafer edge residue in accordance with an aspect of the present invention. The system 500 applies a solution to wafer edge surfaces that removes strongly adhered residue (e.g., carbon and/or fluorine containing residue) and non-strongly adhered residue. The system 500 is described at a high level in order to facilitate understanding of the present invention.

The system 500 for removing wafer edge residue comprises a wafer holding mechanism 502, a solution dispenser 504, a residue remover solution 506, and operates on a target wafer 508. The wafer holding mechanism 502 can be in a variety of forms, shapes, sizes, and compositions in order to safely and securely hold the target wafer 508 during residue removal. In one example, the wafer holding mechanism comprises a series of prongs that come in contact with the top or bottom surface of the wafer and hold the wafer 508 in place. The wafer holding mechanism 502 is comprised of a material, such as silicon carbide, that mitigates contamination of the target wafer 508. It is noted that edge residue removal often occurs after substantial semiconductor device fabrication has been performed on a top surface of the target wafer 508. These formed layers and structures can be easily damaged and/or contaminated resulting in a substantial loss. As a result, the wafer holding mechanism 502 is designed/configured so that damage to formed devices on the top surface of the target wafer 508 is mitigated. For example, fingers and or suction can be employed by the wafer holding mechanism 502 to hold the top and/or bottom surfaces of the target wafer 508. Additionally, the wafer holding mechanism 502 can be configured to hold the wafer 508 only on the bottom surface, thereby further mitigating damage and/or contamination by the holder 502 to the top surface of the wafer 508.

The target wafer 508 is comprised of a semiconductor material, such as silicon, and has the top surface, bottom surface, and edge surface, as described above. The edge surface has strongly adhered residue attached thereto. As stated previously, the strongly adhered residue generally comprises carbon and/or fluorine and is generally not removable with conventional wafer cleaning processes. Typical sources for the strongly adhered residue are wafer holders, such as cassettes or boats, and wafer transfer devices. Such sources of residue are comprised of carbon based materials, such as poly-tetra-fluoro-ethylene (PTFE), poly-flourinated-acitate (PFA), poly-vinyl-di-flouride (PVDF), and the like. As a result, these sources deposit carbon chain based material that tends to be more strongly adhered than other types of residue. Additionally, these sources mechanically smear or attach due to physical interaction with the wafer edges. This is further exacerbated when the surface interaction occurs between a dry surface and a dry wafer. This mechanical interaction increases the adherence of this residue to the wafer edge surface.

The solution dispenser 504 applies the residue remover solution 506 to the edge surface of the target wafer 508. The solution dispenser 504 comprises nozzles and connections thereto from a reservoir (not shown) that stores the residue remover solution 506. The solution dispenser 504 controls a number of parameters employed in dispensing the residue remover solution 506 including, but not limited, initial dispersion point, flow rate, solution composition, duration, temperature, and the like. The solution dispenser 504 can selectively apply the residue remover solution to only selected/targeted portions of the wafer 508, including only the wafer edge surface, the wafer edge surface and the top surface, the wafer edge surface and the bottom surface, and the like. The solution dispenser 504 can, in an alternate aspect, cover or immerse the wafer 508 in the residue remover solution 506. Further details of possible implementations of suitable solution dispensers are provided infra.

The residue remover solution 506 comprises an etch chemistry, a dissolving/cleaning chemistry, and/or a combination thereof. The etch chemistry or cleaning chemistry removes the strongly adhered residue from the wafer edge surfaces without substantially impacting or altering the top surface of the wafer 508. The etch chemistry comprises a solvent or acid that removes semiconductor material underlying the adhered residue thereby breaking the residue from the edge surface. The cleaning chemistry dissolves the adhered residue thereby removing the residue from the edge surface. Suitable solutions employ an etching component, such as hydrofluoric acid, mixed in water and/or an organic solvent.

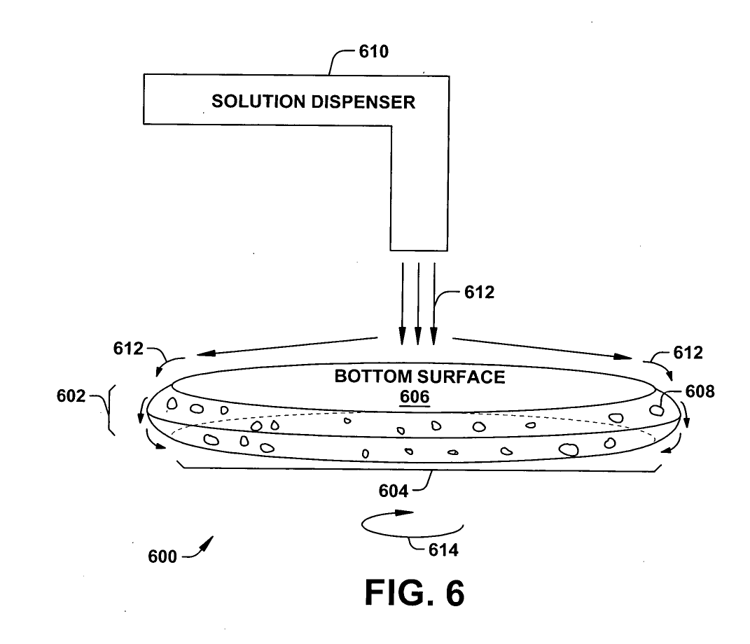

Turning now to FIG. 6, a view illustrating a solution dispenser 610 within an edge residue removal system that directs a residue remover solution toward a bottom surface 606 of a wafer 600 in accordance with an aspect of the present invention is provided. The view describes a possible implementation of the solution dispenser, however it is appreciated that the present invention is not limited to this particular solution dispenser and includes other suitable solution dispensers and variations thereof that apply/provide residue remover solution to edge/bevel portions of target wafers.

The target wafer 600 is shown that has an edge surface 602, a top surface 604, and a bottom surface 606 and is comprised of a semiconductor material, such as silicon. The edge surface 602 is non-planer and may be parabolic. The edge surface 602 is located at an outermost edge of the wafer 600 and has strongly adhered residue 608 attached thereto. A top surface 604 is partially hidden and generally comprises partially formed semiconductor devices thereon. This top surface 604 is sensitive to solutions such as the residue remover solution 612 because such solutions can damaged the structures and layers formed thereon. The top surface 604 is substantially planer. The bottom surface 606 does not typically have semiconductor devices formed thereon and is typically a planar surface of semiconductor material. The bottom surface 606, unlike the top surface 604, is not particularly sensitive to solutions such as the residue remover solution 612 as there are no structures and/or layers that can be damaged.

The solution dispenser 610 obtains the residue remover solution 612 from a reservoir or other solution source (not shown). The solution dispenser 610 is located above the wafer 600 and directs the residue remover solution 612 towards a central portion of the bottom surface 606. The residue remover solution 612 flows from the central portion toward edges of the wafer 600 and eventually wraps around the edge portion 602 as shown in FIG. 6. At the same time, an inert gas, such as nitrogen, is typically sprayed onto the top surface 604. The solution dispenser 610 can adjust an amount of overage, which is the radial distance from the outer edge toward a central portion of the top surface, by adjusting parameters including, but not limited to, flow rate, solution composition, duration, rotational speed of the wafer 600, and the like. Generally, the solution dispenser 610 controls the parameters such that most of the edge surface 602 is in contact with the residue remover solution 612 without a substantial portion of the top surface 604 being in contact with the residue remover solution 612. As a result of being in contact with the edge surface 602, the residue remover solution 612 removes the strongly adhered residue 608.

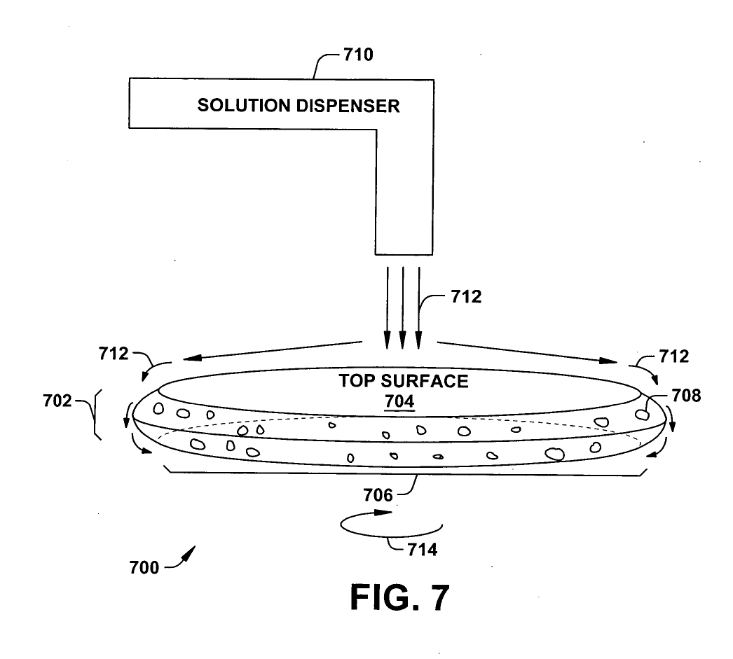

Turning now to FIG. 7, a view illustrating a solution dispenser 710 within an edge residue removal system that directs a residue remover solution 712 towards a top surface 704 of a target wafer 700 in accordance with an aspect of the present invention is provided. The view describes a possible implementation of the solution dispenser, however it is appreciated that the present invention is not limited to this particular solution dispenser and includes other suitable solution dispensers and variations thereof that apply/provide residue remover solution to edge/bevel portions of target wafers.

A target wafer 700 is shown that has an edge surface 702, a top surface 704, and a bottom surface 706 and is comprised of a semiconductor material, such as silicon. The edge surface 702 is non-planer and may be parabolic. The edge surface 702 is located at an outermost edge of the wafer 700 and has strongly adhered residue 708 attached thereto. A top surface 704 is partially hidden and generally comprises partially formed semiconductor devices thereon. This top surface 704 is substantially planar and can be damaged by some cleaning solutions, such as the residue remover solution 712, because such solutions can damage the structures and layers formed thereon. The bottom surface 706 does not typically have semiconductor devices formed thereon and is typically a planar surface of semiconductor material. The bottom surface 706, unlike the top surface 704, is not particularly sensitive to solutions such as the residue remover solution 712 as there are no structures and/or layers that can be damaged.

The solution dispenser 710 obtains the residue remover solution 712 from a reservoir or other solution source (not shown). The solution dispenser 710 is located above the wafer 700 and directs the residue remover solution 712 towards a central portion of the top surface 704. The residue remover solution 712 flows from the central portion toward edges of the wafer 700 and eventually wraps around the edge portion 702 as shown in FIG. 7. The solution dispenser 710 can adjust an amount of overage, which is the radial distance from the outer edge toward a central portion of the bottom surface, in this aspect, by adjusting parameters including, but not limited to, flow rate, solution composition, duration, rotational speed, and the like. Generally, the solution dispenser 710 controls the parameters such that most of the edge surface 702 is in contact with the residue remover solution 712. As a result of being in contact with the edge surface 702, the residue remover solution 712 removes the strongly adhered residue 708.

Unlike the residue remover solution 612 of FIG. 6, the residue remover solution 712 is of a chemistry and composition that mitigates damage to the top surface 704. Some examples of suitable solutions that can be employed include ammonium hydroxide mixed with hydrogen peroxide and de-ionized water, or dilute ammonium hydroxide and the like. Other compositions, such as hydrofluoric acid (HF), phosphoric acid (H3PO4), citric acid, and the like, can be employed if a sufficient amount of dilution is employed. Generally, dilution and/or lower temperatures can be employed to mitigate etching and/or damage to the top surface and still allow removal of the strongly adhered residue 708.

It is noted that applying the residue remover solution 712 can remove/etch the top surface 704, which can be accounted for in previous depositions. For example, a PMD liner can be formed with an extra thickness of 100 Angstroms assuming that 100 Angstroms will be removed during the edge cleaning process in order to protect structures on the top surface 704.

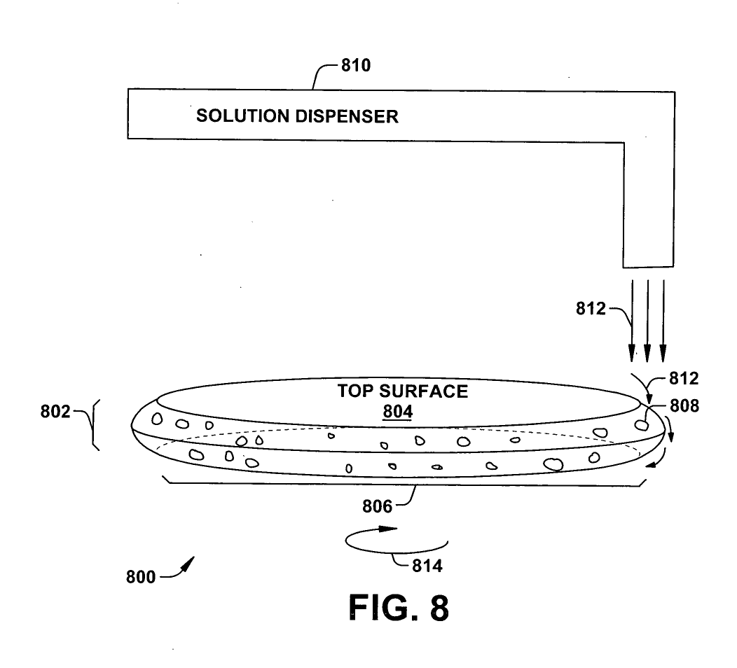

Turning now to FIG. 8, a view illustrating a solution dispenser 810 within an edge residue removal system that selectively directs residue remover solution 812 towards an edge surface 802 of a wafer 800 in accordance with an aspect of the present invention is provided. The view describes a possible implementation of the solution dispenser, however it is appreciated that the present invention is not limited to this particular solution dispenser and includes other suitable solution dispensers and variations thereof that apply/provide residue remover solution to edge/bevel portions of target wafers.

The target wafer 800 is shown that has an edge surface 802, a top surface 804, and a bottom surface 806 and is comprised of a semiconductor material, such as silicon. The edge surface 802 is non-planer and may be parabolic. The edge surface 802 is located at an outermost edge of the wafer 800 and has strongly adhered residue 808 attached thereto. A top surface 804 is substantially planer and generally comprises partially formed semiconductor devices thereon. This top surface 804 is sensitive to solutions such as the residue remover solution 812 because such solutions can damage the structures and layers formed thereon. The bottom surface 806 is partially hidden and is also substantially planer. The bottom surface 806 does not typically have semiconductor devices formed thereon and is typically a planar surface of semiconductor material. The bottom surface 806, unlike the top surface 804, is not particularly sensitive to solutions such as the residue remover solution 812 as there are no structures and/or layers that can be damaged.

The solution dispenser 810 obtains the residue remover solution 812 from a reservoir or other solution source (not shown). The solution dispenser 810 is located above the wafer 800 and directs the residue remover solution 812 towards the edge surface 802. At the same time, an inert gas, such as nitrogen, is typically sprayed onto the top surface 804. The target wafer 800 is rotated to permit coverage along the outer edge of the wafer 800. The residue remover solution 812 flows from the central portion toward edges of the wafer 800 as shown in FIG. 8 and mostly covers the edge surface 802 without substantially covering the top surface 804. The solution dispenser 810 can adjust coverage of the edge surface 802 by adjusting parameters including, but not limited to, flow rate, target position, solution composition, duration, and the like. As a result of being in contact with the edge surface 802, the residue remover solution 812 removes the strongly adhered residue 808.

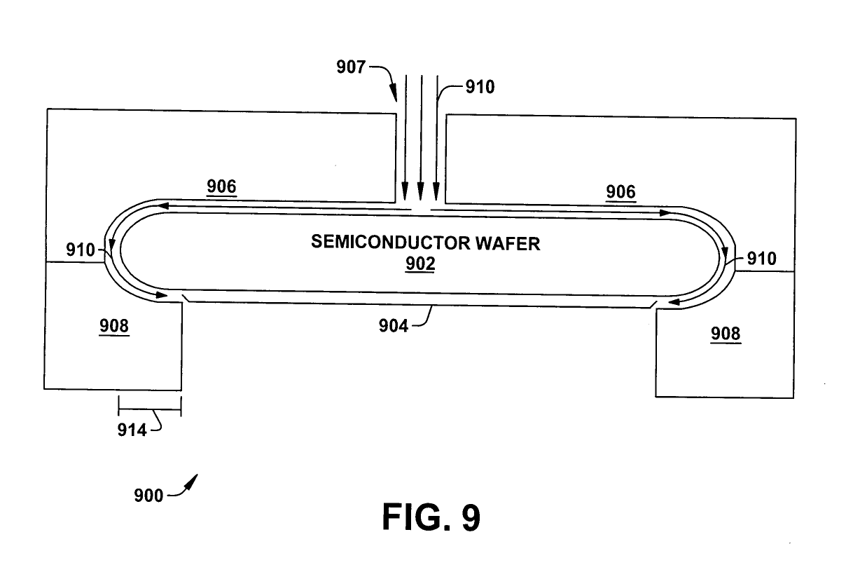

FIG. 9 is a cross sectional view illustrating a solution dispenser comprising a capillary chuck 900 in accordance with an aspect of the present invention. The view describes a possible implementation of the solution dispenser, however it is appreciated that the present invention is not limited to this particular solution dispenser and includes other suitable solution dispensers and variations thereof that apply/provide residue remover solution to edge/bevel portions of target wafers.

A target wafer 902 is shown that has an edge surface, a top surface 904, and a bottom surface and is comprised of a semiconductor material, such as silicon. The edge surface is non-planer and may be parabolic. The edge surface is located at an outermost edge of the wafer 902 and has strongly adhered residue (not shown) attached thereto. A top surface 904 generally comprises partially formed semiconductor devices thereon. This top surface 904 is sensitive to solutions such as the residue remover solution 910 because such solutions can damage the structures and layers formed thereon. The top surface 904 is substantially planer. The bottom surface is opposite the top surface 904 and does not typically have semiconductor devices formed thereon and is also typically a planar surface of semiconductor material. The bottom surface, unlike the top surface 904, is not particularly sensitive to solutions such as the residue remover solution 910 as there are no structures and/or layers that can be damaged.

The capillary chuck 900 comprises a top portion 906 and a bottom portion 908. The top portion 906 substantially covers the bottom surface of the wafer 902 and facilitates flowing residue remover solution 910 toward and onto a bottom portion of the edge surface of the wafer 902. The top portion 906 includes an inlet 907 that allows entry of the residue remover solution 910. The bottom portion 908 covers a top portion of the edge surface and facilitates flowing of the residue remover solution 910 onto the top portion of the edge surface. The shape of the bottom portion 908 of the capillary chuck 900 is such that the residue remover solution does not substantially come in contact with the top surface 904 and, therefore, mitigates damage to structures and layers formed thereon. An interior edge of the bottom portion 908 extends inward a selected distance or overage amount from an outer edge of the wafer 902 in order to provide appropriate coverage.

It is noted that a residue removal system may contain multiple capillary chucks of varied sizes in order to account for varied sized wafers and varied edge surface profiles. Also, coverage of the residue remover solution can be adjusted by altering rotational speed of the wafer and/or chuck 900, flow rate of the residue remover solution 910, composition of the residue remover solution 910, and the like.

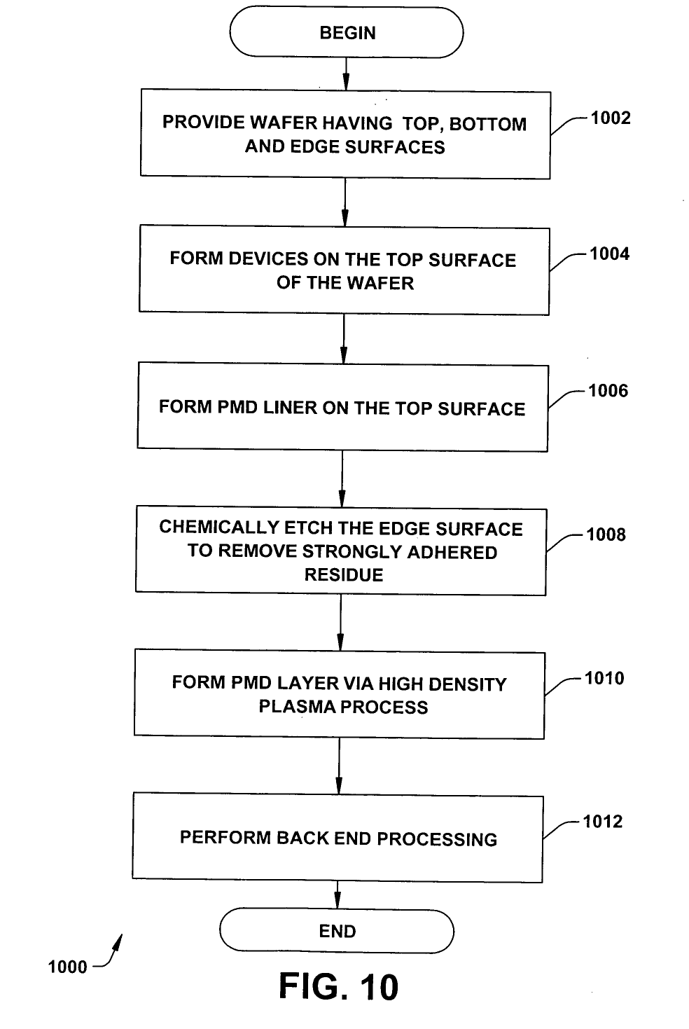

Referring now to FIG. 10, a flow diagram illustrating a method 1000 for removing residue from edge surfaces of a semiconductor wafer in accordance with an aspect of the present invention is illustrated. While the method 1000 is illustrated and described as a series of acts or events, it will be appreciated that the present invention is not limited by the illustrated ordering of such acts or events. For example, some acts may occur in different orders and/or concurrently with other acts or events apart from those illustrated and/or described herein, in accordance with the invention. In addition, not all illustrated steps may be required to implement a methodology in accordance with the present invention.

The method 1000 begins at block 1002, wherein a wafer comprised of a semiconductor material and having a top surface, a bottom surface and an edge surface is provided. The top surface and the bottom surface are substantially planar and on opposite surfaces of the wafer. The edge surface is non planar and may be parabolic profile. Additionally, the edge surface is located on an outer edge of the wafer.

Transistor devices are formed on the semiconductor wafer at block 1004 by performing a series of fabrication processes that form source/drain regions, gate structures, isolation regions, and the like on the top surface of the wafer. The formed transistor devices can include n-type and/or p-type transistor devices. Additionally, silicide regions are typically formed on the source/drain regions and on the gate structures in order to reduce contact resistance and facilitate operation of the fabricated devices. Strongly adhered residue containing carbon can be formed on the edge surfaces as a byproduct of the fabrication processes performed at block 1004.

A pre-metal dielectric liner is formed over the top surface of the wafer at block 1006 by depositing and/or forming a suitable liner material such as nitride. The pre-metal dielectric liner mitigates undesired dopant diffusion to later formed layers and facilitates subsequent formation of a pre-metal dielectric layer. Again, strongly adhered residue containing carbon can be formed on the edge surfaces as a by-product of the liner formation performed at block 1006.

Strongly adhered residue located on edge surfaces of the wafer is removed at block 1008 by applying a residue remover solution to the edge surface. The residue remover solution etches semiconductor material underlying the strongly adhered residue thereby removing it from the wafer edge surfaces. Typically, the residue remover solution includes an etch component, such as hydrofluoric acid.

The residue remover solution can be applied to the edge surface in a number of suitable manners. For example, the residue remover solution can be directionally applied to only the wafers edge while the wafer itself is rotated. As another example, the residue remover solution can be applied to a bottom surface of a wafer and permitted to wrap around to the edge surface. In another example, the residue remover solution can be applied to a top surface of a wafer and permitted to wrap around the edge surface from the top surface. In such a case, the liner formed at block 1006 should be formed with added thickness to account for a partial removal thereof due to the residue remover solution at block 1008.

Subsequently, a high density plasma process is performed to form a pre-metal dielectric layer on the pre-metal dielectric liner at block 1010. High density plasma processes contain etch and deposition components and can undesirably dislodge strongly adhered residue from edge surfaces of the wafer. This dislodged residue, if present, could form in a layer being formed by high density plasma processes as shown and discussed with respect to FIG. 4. However, the method 1000 removes the strongly adhered residue at block 1008 and, as a result, there is no strongly adhered residue remaining that can be displaced and become lodged in the pre-metal dielectric layer. Thereafter, back end processing is performed at block 1012 including, but not limited to, contact and via formation, metal layer formation, and the like.

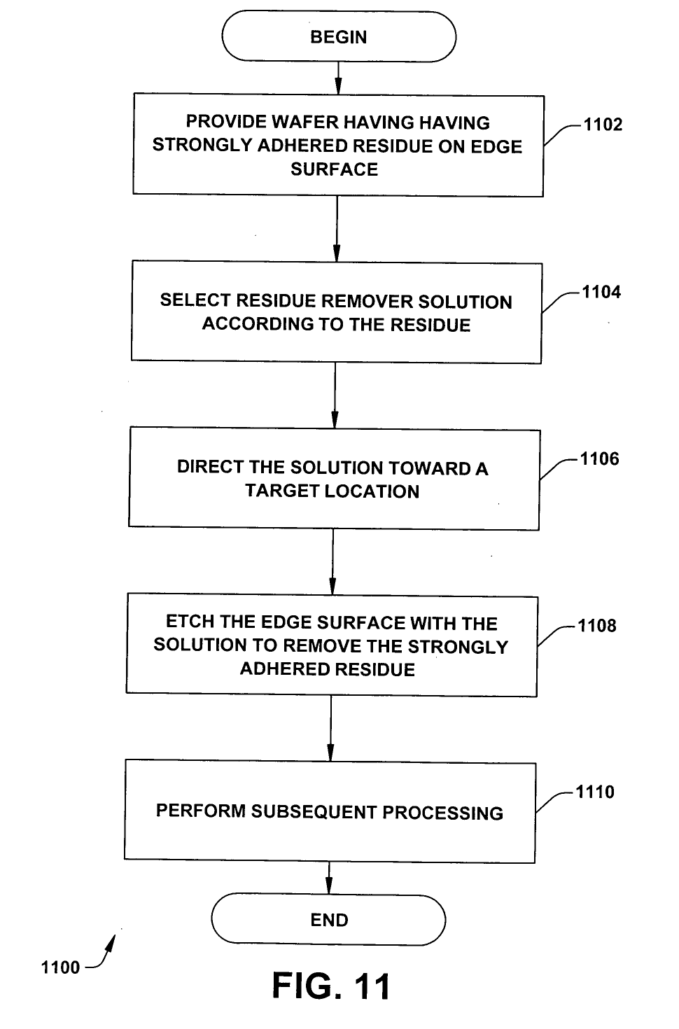

FIG. 11 is a flow diagram illustrating a method 1100 for removing residue from edge surfaces of a semiconductor wafer in accordance with an aspect of the present invention. While the method 1100 is illustrated and described as a series of acts or events, it will be appreciated that the present invention is not limited by the illustrated ordering of such acts or events. For example, some acts may occur in different orders and/or concurrently with other acts or events apart from those illustrated and/or described herein, in accordance with the invention. In addition, not all illustrated steps may be required to implement a methodology in accordance with the present invention.

The method 1100 begins at block 1102, wherein a wafer comprised of semiconductor material, a planar top surface, a planar bottom surface, and a non-planar edge surface is provided. The top surface typically has semiconductor devices formed thereon. The edge surface has strongly adhered residue, such as carbon based residue, formed thereon as a result of fabrication processes and material from wafer holders (e.g., poly-tetra-fluoro-ethylene).

A residue remover solution is selected at block 1104 according to the semiconductor material of the wafer, the strongly adhered residue present or expected to be present, and the semiconductor devices formed on the top surface of the wafer. Generally, the residue remover solution comprises an etch component, such as hydrofluoric acid within water and/or an organic solution.

The residue remover solution is applied to a target location on the wafer with a selected flow rate while the wafer is rotated at block 1106. The target location can be, for example, a centerpoint of the bottom surface, a centerpoint of the top surface, a portion of the edge surface, and the like. A gas, such as nitrogen, can be applied to the top surface of the wafer in order to mitigate or prevent the residue remover solution from coming into contact with the top surface.

The residue remover solution comes in contact with the edge surface and removes semiconductor material underlying the strongly adhered residue thereby removing the strongly adhered residue at block 1108. The residue remover solution comes in contact with the edge surface as a result of the application flow rate and rotation of the wafer at block 1106 and reacts and removes semiconductor material from the edge surface. As a result, semiconductor material located under strongly adhered residue is removed thereby removing the residue.

Although the invention has been illustrated and described with respect to one or more implementations, equivalent alterations and modifications will occur to others skilled in the art upon the reading and understanding of this specification and the annexed drawings. In particular regard to the various functions performed by the above described components (assemblies, devices, circuits, systems, etc.), the terms (including a reference to a “means”) used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the invention. In addition, while a particular feature of the invention may have been disclosed with respect to only one of several implementations, such feature may be combined with one or more other features of the other implementations as may be desired and advantageous for any given or particular application. Furthermore, to the extent that the terms “including”, “includes”, “having”, “has”, “with”, or variants thereof are used in either the detailed description and the claims, such terms are intended to be inclusive in a manner similar to the term “comprising.”

What is claimed is:

1. A system for removing wafer edge residue comprising:
a wafer comprised of semiconductor material having a planer top surface, a bottom surface and an edge surface, wherein strongly adhered residue is initially formed on the edge surface;
a holding mechanism that holds the wafer and exposes the edge surface; and
a solution dispenser that dispenses a residue remover solution on the edge surface, wherein the residue remover solution etches the edge surface, which removes the strongly adhered residue from the edge surface.

2. The system of claim 1, wherein the solution dispenser dispenses the residue remover solution on only the edge surface.

3. The system of claim 1, wherein the solution dispenser dispenses the residue remover solution on the bottom surface and the edge surface.

4. The system of claim 1, wherein the holding mechanism comprises a plurality of prongs in contact with the bottom surface of the wafer.

5. The system of claim 1, wherein the solution dispenser comprises a capillary chuck that dispenses the residue remover solution on the edge surfaces to a selected distance from an outer edge of the wafer.

6. The system of claim 1, wherein the solution dispenser dispenses the residue remover solution toward a center point of the bottom surface with a flow rate selected to cover the edge surface without substantially covering the top surface.

7. The system of claim 1, wherein the residue remover solution etches the edge surface to remove underlying semiconductor material in order to remove the strongly adhered residue.

8. The system of claim 1, wherein the residue remover solution comprises hydrofluoric acid.

9. The system of claim 1, wherein the residue remover solution comprises hydrofluoric acid in an organic solution.

10. The system of claim 1, wherein the residue remover solution comprises sulfuric acid.

11. The system of claim 1, wherein the holding mechanism rotates the wafer at a selected rotational speed.

12. The system of claim 1, further comprising an inert gas dispenser that dispenses inert gas onto the top surface of the wafer.

13. The system of claim 1, wherein the strongly adhered residue comprises carbon and fluorine.

14. A system for removing wafer edge residue comprising:
a wafer comprised of a semiconductor material having a top surface, a bottom surface, and an edge surface, wherein the top and bottom surfaces are substantially planer and the edge surface is non-planer;
a capillary chuck comprising:
a top portion surrounding at least a portion of the bottom surface of the wafer and a bottom portion of the edge surface and having an inlet for receiving a residue remover solution; and
a bottom portion surrounding at least a portion of the top surface and a top portion of the edge surface and located underneath the top portion and separated by a gap there between, wherein an interior edge of the bottom portion extends an overage amount from an outer edge of the wafer; and
a solution dispenser that dispenses the residue remover solution to the inlet of the capillary chuck.

15. The system of claim 14, wherein the gap is a function of a thickness of the wafer.

16. The system of claim 14, wherein the residue remover solution comprises hydrofluoric acid in water.

17. The system of claim 14, wherein the strongly adhered residue comprises carbon.

18. A method for removing residue from edge surfaces of semiconductor wafers comprising:
providing a wafer comprised of a semiconductor material having a top surface, a bottom surface and edge surfaces, wherein the bottom surface and the top surface are substantially planer, the edge surface is non-planer, and strongly adhered residue is formed on the edge surface;
selecting a residue remover solution according to the strongly adhered residue and the semiconductor material; and
applying the residue remover solution to the edge surface and removing the strongly adhered residue from the edge surface.

19. The method of claim 18, wherein applying the residue remover solution comprises selectively applying the residue remover solution to only the edge surfaces.

20. The method of claim 18, wherein applying the residue remover solution comprises selectively applying the residue remover solution to the edge surface and the bottom surface.

21. The method of claim 18, wherein applying the residue remover solution comprises selectively applying the residue remover solution to the edge surface and the top surface.

22. The method of claim 18, further comprising rotating the wafer while applying the residue remover solution to the edge surface.

23. A method for removing residue from edge surfaces of semiconductor wafers comprising:
providing a wafer comprised of a semiconductor material having a top surface, a bottom surface and edge surfaces, wherein the bottom surface and the top surface are substantially planer, and the edge surface is non-planer;
forming transistor devices on the top surface of the wafer and forming strongly adhered residue on the edge surfaces as a result;
forming a dielectric liner over the top surface of the wafer;
etching the edge surface of the wafer with a residue remover solution to remove the strongly adhered residue; and
performing a high density plasma deposition process to form a dielectric layer on the dielectric liner.

24. The method of claim 23, wherein the dielectric liner is a pre-metal dielectric liner and the dielectric layer is a pre-metal dielectric layer.

25. The method of claim 23, wherein forming the dielectric liner comprises forming the dielectric liner with an extra thickness, wherein the extra thickness accounts for expected removal during the etching of the edge surface.
